(19) United States
(12) Patent Application Publication
(10) Pub. No.: US 2004/0258608 A1
(43) Pub. Date: Dec. 23, 2004

(54) Stable dispersions of nanoparticles in aqueous media

(76) Inventors: Roger H. Cayton, Naperville, IL (US); Richard W. Brotzman JR., Naperville, IL (US); Patrick G. Murray, Yorkville, IL (US)

Correspondence Address: WILDMAN, HARROLD, ALLEN & DIXON, 225 WEST WACKER DRIVE, CHICAGO, IL, 60606, US

(21) Appl. No.: 10/357,941

(22) Filed: Feb. 4, 2003

Related U.S. Application Data
(60) Provisional application No. 60/354,184, filed on Feb. 4, 2002.

(51) Int. Cl. C01F 17/00

(52) U.S. Cl. 423/592.1; 423/263

(57) ABSTRACT

A process to prepare a stable dispersion of nanoparticles in aqueous media. A dispersant and aqueous are combined to form a mixture. The dispersant is selected from the group comprising copolymers and cyclic phosphates. Nanoparticles are added to the mixture to form the dispersion.

### CROSS REFERENCE TO RELATED APPLICATION

This application claims the priority from U.S. Provisional Application No. 60/354,184 filed on Feb. 4, 2002.

### FIELD OF THE INVENTION

The present invention relates to dispersions of nanoparticles in aqueous media, and more specifically to stable aqueous dispersions of nanocrystalline metals and metal oxides.

### BACKGROUND OF THE INVENTION

Stable aqueous-based dispersions of nanoparticles, such as substantially spherical nanocrystalline metals and/or metal oxides would be useful for many applications. Such dispersions could serve as a component of transparent coatings, which could be used on surfaces to yield unique properties such as abrasion resistance, radiation absorption or reflection, electrical conductivity, and catalytic function. Other applications of dispersions include, but are not limited to, functioning as abrasive or polishing fluids, thermal transfer fluids, catalytic additives, ingredients to cosmetic and personal care formulations, and electro-rheological fluids.

Generally products utilizing the dispersions described above have different pH values than the natural pH of metal and/or metal oxides in water. This often leads to dispersion instability because, as the dispersion pH is adjusted for application use, the isoelectric point of the dispersed phase is encountered and flocculation of the nanoparticles is initiated. Thus, it would be desirable to form stable aqueous-based dispersions at pH values required by the application, especially pH values above or near the isoelectric point of the metal and/or metal oxide. Therefore, a need exists for a method of preparation of stable dispersions of nanoparticles, such as substantially spherical nanocrystalline metals and/or metal oxides, and aqueous media at a variety of pH values.

### SUMMARY OF THE INVENTION

In one example, the present invention relates to a method of preparing or forming stable dispersions of nanoparticles and aqueous media. The method comprises combining a dispersant with aqueous media to form a mixture. The dispersant in one example is selected from the group comprising water soluble copolymers and cyclic phosphates. Nanoparticles, such as substantially spherical nanocrystalline metal and/or metal oxide particles are added to the mixture.

### DETAILED DESCRIPTION OF THE INVENTION

Following are definitions of terms that are used throughout the description:

Isoelectric point—the pH of zero net charge on a nanoparticle in dispersion. The isoelectric point is determined by measuring the zeta-potential of a nanoparticle dispersion and a buffer to maintain dispersion pH. The pH where the zeta-potential is zero is the isoelectric point.

Long-term stable dispersion—the dispersed nanoparticles do not aggregate (no increase in particle size) and gravitational sedimentation is minimized on the time frame of 6 months and longer.

Short-term stable dispersion—the dispersed nanoparticles are initially well dispersed but begin to aggregate, displaying an increased particle size and concomitant sedimentation, on the time frame of days to weeks.

Water-soluble dispersants are used in a method of dispersing nanoparticles, such as substantially spherical metal and/or metal oxide nanoparticles. In one example, the nanoparticles comprise the nanocrystalline materials described in U.S. Pat. No. 5,874,684, entitled “Nanocrystalline Materials”, which was granted to Parker et al. on Feb. 23, 1999, and which is hereby incorporated by reference. The aqueous-based dispersions, of the present invention, are made by dissolving dispersant in water and adding the nanoparticles while high shear mixing (e.g., ultrasonication, rotor-stator mixing, homogenizer mixing, etc.) Substantially spherical nanocrystalline metals and/or metal oxides are dispersed above their isoelectric points using a variety of water soluble dispersants, including but not limited to, pigment dispersants, surfactants, wetting agents, coupling agents (hereinafter referred to collectively in this document as “dispersants”). The dispersants range from small molecules to oligomeric materials to polymers to coupling agents and featured a variety of different surface anchoring groups (acidic, basic, or neutral), and had different ionic character (cationic, anionic, or neutral).

Screenings were conducted utilizing the dispersants to disperse substantially spherical nanocrystalline metals and metal oxides. Experiments were constructed to cover a number of different particle concentrations as well as a number of different dispersant levels with respect to the particle. Samples were prepared by ultrasonication and the quality of dispersion was measured by the following criteria:

1. Qualitative appearance of the dispersion

2. Particle size determination

3. Dispersion stability with respect to gravimetric sedimentation over time

Surfactants, such as those given in the examples which follow, were employed to obtain stable dispersions of substantially spherical nanocrystalline metal and metal oxide particles. The pH was adjusted above the isoelectric point of the particles with hydroxide bases. Surprisingly, only water-soluble copolymers and, for some nanoparticles, cyclic phosphates, were found to yield stable aqueous-based dispersions of substantially spherical nanocrystalline metals and/or metal oxides above the isoelectric point of the particles. The resulting aqueous-based dispersions of substantially spherical nanocrystalline particles are stable, have a pH greater that the isoelectric point of the particles in an aqueous-based medium, and could be incorporated into application formulations without inducing flocculation of the particles.

A description of several exemplary experiments now follows for illustrative purposes.

### EXAMPLE 1

### Aqueous-Based Dispersions of Substantially Spherical Nanocrystalline Aluminum Oxide

Dispersants evaluated in aqueous-based dispersions of aluminum oxide are listed in Table 1. Commercial dispersant names, maximum weight percent oxide in a fluid dispersion, weight percent dispersant with respect to aluminum oxide, mean particle size in dispersion on a volume-weight basis in dispersions as made, dispersion stability after the dispersion pH was increased above the isoelectric point of aluminum oxide dispersion using hydroxide bases (stable dispersion=S, long term—LT, short term—ST, flocculated dispersion=F), and dispersant type are tabulated. The dispersions that were initially stable were monitored over time and were further characterized. The general dispersion effectiveness falls into two groups depending on the length of time the dispersion remains stable. Long-term stable dispersions are stable for at least 6 months and do not exhibit aggregation and particle size growth. However, short-term stable dispersions exhibit aggregation and particle size growth on the time frame of days to weeks.

Only water-soluble copolymers that have polymer segments that are attractive to the nanocrystalline particle and different polymer segments that render them water-soluble yield 5 long-term stable dispersions. This is a surprising result—homopolymers of acrylic acid as a class only render the dispersions stable for short times.

TABLE 1
Dispersants for Aqueous-Based Aluminum Oxide Dispersions

| | Max | | Initial | | |
|---|---|---|---|---|---|
| | Oxide | Disp | PS, nm | Dispersion | |
| Dispersant | wt % | wt % | <d>vol | Stability | Dispersant Type |
| Long Term Stable | | | | | |
| Polyacryl C50-45AN | 65 | 10 | 135 | S - LT | Acrylamidomethylpropane sulfonic acid/acrylic acid |
| | | | | | copolymer, neutral to pH = 8 |
| Tego 752W | 65 | 10 | 135 | S - LT | Maleic acid/vinyl polyether copolymer, pH = 6 |
| Disperbyk-190 | 50 | 10 | 135 | S - LT | Non-Ionic copolymer with carboxy anchor groups, |
| | | | | | pH = 7 |
| Zephrym PD3315 | 50 | 10 | 135 | S - LT | Propylene oxide/acrylic acid copolymer, pH = 8 |
| Short Term Stable | | | | | |
| Hydropalat 44 | 20 | 10 | 150 | S - ST | Acrylic acid homopolymer, pH = 7.8 |
| Polacryl A60-40S | 20 | 10 | 150 | S - ST | Acrylic acid homopolymer, pH = 8.0 |
| Polacryl B55-50AN | 20 | 10 | 150 | S - ST | Acrylic acid homopolymer, pH = 6.5 |
| Polacryl A60-35S | 40 | 10 | 150 | S - ST | Acrylic acid homopolymer, pH = 8.0 |
| Hydropalat 100 | 10 | 20 | 150 | S - ST | Acrylic acid homopolymer, pH = 6.5 |
| HMP | 20 | 2 | 150 | S - ST | Sodium hexametaphosphate, ring structure |
| Unstable | | | | | |
| Solsperse 27000 | 0 | 5 | >500 | F | Nonionic polymer |
| PVP K-15 | 0 | 10 | >500 | F | Polyvinylpropylidone, MW = 9700 |
| Ganex P-904 LC | 0 | 5 | >500 | F | 90% PVP/10% Poly-C4, HLB = 18-20 |
| Solsperse 20000 | 0 | 10 | >500 | F | Cationic polymer |
| Solsperse 40000 | 0 | 20 | >500 | F | Anionic polymer neutralized with DEA |
| Solsperse 41090 | 0 | 20 | >500 | F | Anionic polymer, pH = 2-3 |
| PVP/VA S-630 | 0 | 10 | >500 | F | Polyvinylpropylidone/Vinyl acetate |
| Hydropalat 3216 | 0 | 20 | >500 | F | Nonionic and Ionic Surfactants |

### EXAMPLE 2

### Aqueous-Based Dispersions of Substantially Spherical Nanocrystalline Cerium Oxide

Dispersants evaluated in aqueous-based dispersions of cerium oxide are listed in Table 2. Commercial dispersant names, weight percent oxide in dispersion, weight percent dispersant with respect to cerium oxide, mean particle size in dispersion on a volume-weight basis in dispersions as made, dispersion stability after the dispersion pH was increased above the isoelectric point of cerium oxide dispersion using hydroxide bases (stable dispersion=S, long term—LT, short term—ST, flocculated dispersion=F), and dispersant type are tabulated. The dispersions that were initially stable were evaluated over time and were further characterized. As with alumina, the general dispersion effectiveness for ceria falls into two groups depending on the length of time the dispersion remains stable—long-term and short-term stable dispersions.

Only water-soluble copolymers that have polymer segments that are attractive to the nanocrystalline particle and polymer segments that render them water-soluble yield long-term stable dispersions. This is a surprising result—homopolymers of acrylic acid as a class only render the dispersions stable for short times. In the case of unstable dispersions the observed flocculation is irreversible.

TABLE 2
Dispersants for Aqueous-Based Cerium Oxide Dispersions

| | | | Initial | | |
|---|---|---|---|---|---|
| | Oxide | Disp | PS, nm | Dispersion | |
| Dispersant | wt % | wt % | <d>vol | Stability | Dispersant Type |
| Long-Term Stable | | | | | |
| Polyacryl C50-45AN | 20 | 10 | 120 | S - LT | Acrylamidomethylpropane sulfonic acid/acrylic acid |
| | | | | | copolymer, neutral to pH = 8 |
| Tego 752W | 20 | 10 | 120 | S - LT | Maleic acid/vinyl polyether copolymer, pH = 6 |
| Disperbyk-190 | 20 | 10 | 120 | S - LT | Non-Ionic copolymer with carboxy anchor groups, |
| | | | | | pH = 7 |
| Zephrym PD3315 | 20 | 10 | 120 | S - LT | Propylene oxide/acrylic acid copolymer, pH = 8 |
| Short-Term Stable | | | | | |
| Polacryl A60-35S | 20 | 10 | 150 | S - ST | Acrylic acid homopolymer, pH = 8.0 |
| Polacryl A60-40S | 20 | 10 | 150 | S - ST | Acrylic acid homopolymer, pH = 8.0 |
| Polacryl B55-50AN | 20 | 10 | 150 | S - ST | Acrylic acid homopolymer, pH = 6.5 |
| Polacryl B55-50A | 20 | 10 | 150 | S - ST | Acrylic acid homopolymer |
| Hydroplat 100 | 20 | 10 | 150 | S - ST | Hydrophobically modified acrylic acid homopolymer |
| Unstable | | | | | |
| PVP K-15 | 0 | 20 | >500 | F | Polyvinylpropylidone, MW = 9700 |
| Solsperse 27000 | 0 | 10 | >500 | F | Nonionic polymer |
| PVP/VA S-630 | 0 | 10 | >500 | F | Polyvinylpropylidone/Vinyl acetate |
| Ganex P-904 LC | 0 | 5 | >500 | F | 90% PVP/10% Poly-C4, HLB = 18-20 |
| HMP | 0 | 2 | >500 | F | Sodium hexametaphosphate, ring structure |
| Solsperse 40000 | 0 | 20 | >500 | F | Anionic polymer neutralized with DEA |
| Solsperse 41090 | 0 | 20 | >500 | F | Anionic polymer, pH = 2-3 |

### EXAMPLE 3

### Aqueous-Based Dispersions of Substantially Spherical Nanocrystalline Zinc Oxide

Dispersants evaluated in aqueous-based dispersions of zinc oxide are listed in Table 3. Commercial dispersant names, maximum weight percent oxide in fluid dispersion, weight percent dispersant with respect to zinc oxide, mean particle size in dispersion on a volume-weight basis in dispersions as made, dispersion stability after the dispersion pH was increased above the isoelectric point of zinc oxide using hydroxide bases (stable dispersion=S, long term—LT, short term—ST, flocculated dispersion=F), and dispersant type are tabulated. The dispersions that were initially stable were evaluated over time and were further characterized. As with alumina and ceria, the general dispersion effectiveness for ceria falls into two groups depending on the length of time the dispersion remains stable—long-term and short-term stable dispersions.

Only water-soluble copolymers that have polymer segments that are attractive to the nanocrystalline particle and polymer segments that render them water-soluble yield long-term stable dispersions. This is a surprising result—homopolymers of acrylic acid as a class only render the dispersions stable for short times.

TABLE 3
Dispersants for Aqueous-Based Zinc Oxide Dispersions

| | Max | | | | |
|---|---|---|---|---|---|
| | Oxide, | Disp, | PS, nm | Dispersion | |
| Dispersant | wt % | wt % | <d>vol | Stability | Dispersant Type |
| Long-Term Stable | | | | | |
| Polyacryl C50-45AN | 40 | 5 | 310 | S - LT | Acrylamidomethylpropane sulfonic acid/acrylic acid |
| | | | | | copolymer, neutral to pH = 8 |
| Disperbyk 190 | 60 | 4 | 310 | S - LT | Non-Ionic copolymer with carboxy anchor groups, |
| | | | | | pH = 7 |
| Zephrym PD3315 | 40 | 3 | 310 | S - LT | Propylene oxide/acrylic acid copolymer, pH = 8 |
| HMP | 30 | 2 | 310 | S - LT | Sodium hexametaphosphate, ring structure |
| Short-Term Stable | | | | | |
| Zephrym PD 3076 | 28 | 10 | 250 | S - ST | Acrylic acid-based homopolymer |
| Hydropalat 44 | 30 | 0.7 | 390 | S - ST | Acrylic acid homopolymer, pH = 7.8 |
| Hydropalat 100 | 30 | 20 | 430 | S - ST | Acrylic acid homopolymer, pH = 6.5 |
| Polacryl A60-35S | 40 | 5 | 390 | S - ST | Acrylic acid homopolymer, pH = 8.0 |
| Polacryl A60-40S | 40 | 5 | 370 | S - ST | Acrylic acid homopolymer, pH = 8.0 |
| Polacryl B55-50AN | 40 | 5 | 300 | S - ST | Acrylic acid homopolymer, pH = 6.5 |
| Unstable | | | | | |
| Polacryl B55-50A | 0 | 10 | >500 | F | Acrylic acid homopolymer, pH = 3.5 |
| PVP K-15 | 0 | 10 | >500 | F | Polyvinylpropylidone, MW = 9700 |
| Hydropalat 3216 | 0 | 20 | >500 | F | Nonionic and Ionic Surfactants |
| Solsperse 20000 | 0 | 5 | >500 | F | Basic, cationic single anchor, single polymer chain |
| Solsperse 27000 | 0 | 5 | >500 | F | Nonionic polymer |
| Solsperse 40000 | 0 | 20 | >500 | F | Anionic polymer neutralized with DEA |
| Solsperse 41090 | 0 | 18 | >500 | F | Anionic polymer |
| Zephrym PD 3800 | 0 | 10 | >500 | F | Nonionic/Anionic Surfactant blend |
| Zephrym PD 3100 | 0 | 10 | >500 | F | Alcohol ethoxylate |
| Zephrym PD 7000 | 0 | 10 | >500 | F | Nonionic surfactant |
| Zephrym PD 2434 | 0 | 20 | >500 | F | Polymeric dispersant |
| Disperbyk 184 | 0 | 20 | >500 | F | Polymeric dispersant |
| Disperbyk 192 | 0 | 20 | >500 | F | Polymeric dispersant |
| PVP/VA S-630 | 0 | 10 | >500 | F | Polyvinylpropylidone/Vinyl acetate |
| Ganex P-904 LC | 0 | 10 | >500 | F | 90% PVP/10% Poly-C4, HLB = 18-20 |
| Copolymer 958 | 0 | 11 | >500 | F | PVP/Dimethylaminoethylmethacrylate copolymer |
| PVP/VA W-635 | 0 | 10 | >500 | F | PVP/vinyl acetate copolymer |
| Hydropalat 188A | 0 | 20 | >500 | F | Polyethyleneglycol dioleate, Nonionic surfactant |
| Hydropalat 535N | 0 | 20 | >500 | F | Oleoalkylenoxide block copolymer |
| Hydropalat 1080 | 0 | 20 | >500 | F | Oleoalkylenoxide block copolymer |
| Zonyl FSO100 | 0 | 2 | >500 | F | Fluorinated surfactant |
| Alkox E-30 | 0 | 10 | >500 | F | Polyethyleneoxide |
| Alkox E-160 | 0 | 10 | >500 | F | Polyethyleneoxide |
| Alkox R-150 | 0 | 20 | >500 | F | Polyethyleneoxide |
| Alkox R-400 | 0 | 20 | >500 | F | Polyethyleneoxide |

### EXAMPLE 4

### Aqueous-Based Dispersions of Other Substantially Spherical Nanocrystalline Particles—Copper Oxide, Silver, Antimony Tin Oxide, Indium Tin Oxide

Long-term stable, aqueous-based dispersions of other substantially spherical nanocrystalline particles—copper oxide, silver, antimony tin oxide, indium tin oxide—are produced using water-soluble copolymer dispersant levels from 1 to 20-wt % dispersant with respect to nanocrystalline particles, depending on the copolymer dispersant used. The copolymer dispersant stabilizes the volume-weighted mean particle size preventing aggregation (the formation of grape-like clusters).

### EXAMPLE 5

### The Stability of Aqueous-Based Dispersions of Substantially Spherical Nanocrystalline Cerium Oxide

The mean particle size, of substantially spherical ceria, in aqueous dispersion at pH 7.5 on a volume-weight basis (measured using dynamic light scattering), as functions of time and dispersant type, are given in Table 4. The mean particle size is stable for Zephrym PD 3315 and Polyacryl C50-45AN, water-soluble copolymers that have polymer segments that are attractive to the nanocrystalline particle and polymer segments that render them water-soluble. Where as the mean particle size grows over time for Polyacryl B55-50AN and Hydropatat 44, homopolymers of acrylic acid. This is a surprising result.—homopolymers of acrylic acid as a class are claimed to render the dispersions stable (see U.S. Pat. No. 5,876,490)

| | PS | PS | PS | PS | PS | PS |
|---|---|---|---|---|---|---|
| Dispersant | 0 days | 1 day | 3 days | 21 days | 54 days | 12 mo |
| Hydropatat 44 | 289 nm | 268 nm | 330 nm | 327 nm | 402 nm | 378 nm |
| Polacryl | 155 nm | 171 nm | 152 nm | 315 nm | 376 nm | 415 nm |
| B55-50AN | | | | | | |
| Zephrym | 173 nm | 212 nm | 141 nm | 163 nm | 200 nm | 216 nm |
| PD 3315 | | | | | | |
| Polyacryl | 178 nm | 155 nm | 146 nm | 172 nm | 180 nm | 196 nm |
| C50-45AN | | | | | | |

### EXAMPLE 6

### Settling Stability of Aqueous Dispersions of Substantially Spherical Nanocrystalline Ceria at Elevated pH

The stability of aqueous dispersions of substantially spherical nanocrystalline ceria at elevated pH with respect to gravitational sedimentation was quantified as a function of dispersant type, dispersant concentration, and pH. A slow rate of gravitational sedimentation is desired in storage containers to minimize the amount of mixing required to homogenize the concentration. For aqueous ceria dispersions the problem is particularly challenging since the density of the ceria is approximately seven times the density of water and for 20-wt % ceria dispersions the dispersion viscosity is less than 10 cP.

Dispersions were prepared using C50-45AN and B55-50AN. Each sample in Table 5 was placed into a 500 mL polypropylene graduated cylinder. The cylinder contained a column of ceria dispersion 27.5 cm high. The graduated cylinder was covered tightly with Parafilm and set aside for 30 days.

TABLE 5
Dispersion Samples in Gravimetric Sedimentation Study

| | weight % Dispersant | initial d<vol> nm |
|---|---|---|
| Sample | (based on ceria) | (SD nm) |
| 114A | 8% C50-45AN | 94 (21) |
| 114B | 9% C50-45AN | 93 (21) |
| 114C | 10% C50-45AN | 94 (21) |
| 114D | 11% C50-45AN | 92 (20) |
| 114E | 12% C50-45AN | 94 (21) |
| 114F | 10% B55-50AN | 94 (22) |

*Horiba LA-910; mean volume weighted PS and standard deviation

After thirty days, 100 mL aliquots (5.5 cm of dispersion) of the ceria dispersion were carefully removed from the cylinder. These aliquots were taken from the top of the cylinder with a polypropylene syringe equipped with a virgin 6″ stainless steel needle, located just beneath the surface of the liquid in a fashion such that the liquid below was not disturbed. Each 100 mL aliquot was stored in a separate 125 mL polypropylene container and named “1” through “5” depending on where in the graduated cylinder it was taken. For example, 114A-1 was taken from the top of the graduated cylinder while 114A-5 was taken from the bottom of the graduated cylinder. Each 100 mL aliquot was characterized by the loss on drying and by Horiba particle size determination. The amount of sediment that would not pour out of the graduated cylinder after 20 seconds of inversion was also determined. These data are presented in Table 6.

TABLE 6
Sediment, solids, and PS for Table 5 Dispersions

| Sample | sediment (g) | % solids (LOD) | d<vol>, nm (SD, nm)* |
|---|---|---|---|
| 114A-1 | | 10.1 | 85 (16) |
| 114A-2 | | 15.2 | 95 (20) |
| 114A-3 | | 16.6 | 103 (22) |
| 114A-4 | | 17.0 | 105 (23) |
| 114A-5 | | 21.2 | 108 (25) |
| 114A-sediment | 10.04 | — | — |
| 114B-1 | | 9.8 | 86 (16) |
| 114B-2 | | 15.2 | 96 (20) |
| 114B-3 | | 16.4 | 103 (23) |
| 114B-4 | | 16.7 | 105 (24) |
| 114B-5 | | 20.2 | 108 (25) |
| 114B-sediment | 9.06 | — | |
| 114C-1 | | 10.9 | 86 (17) |
| 114C-2 | | 15.6 | 97 (20) |
| 114C-3 | | 16.3 | 104 (23) |
| 114C-4 | | 17.1 | 106 (24) |
| 114C-5 | | 21.4 | 109 (25) |
| 114C-sediment | 6.78 | — | |
| 114D-1 | | 10.5 | 86 (16) |
| 114D-2 | | 15.8 | 96 (20) |
| 114D-3 | | 16.7 | 103 (22) |
| 114D-4 | | 16.9 | 106 (24) |
| 114D-5 | | 20.7 | 108 (25) |
| 114D-sediment | 6.94 | — | |
| 114E-1 | | 11.5 | 86 (17) |
| 114E-2 | | 16.1 | 98 (21) |
| 114E-3 | | 17.0 | 105 (23) |
| 114E-4 | | 17.2 | 106 (24) |
| 114E-5 | | 21.2 | 111 (27) |
| 114E-sediment | 7.06 | — | |
| 114F-1 | | 7.5 | 84 (16) |
| 114F-2 | | 9.3 | 87 (17) |
| 114F-3 | | 9.5 | 88 (17) |
| 114F-4 | | 9.3 | 89 (18) |
| 114F-5 | | 21.6 | 120 (37) |
| 114F-sediment | 51.5 | — | |

*Horiba LA-910; mean volume weighted PS and standard deviation

Data in Table 6 show the amount of sediment in C50-45AN samples decreases until 10% C50-45AN is reached, after which there is little improvement to be gained by adding more dispersant. The sediment obtained with the dispersant B55-50AN, a homopolymer of acrylic acid, at 10% by weight (51.5%) is by far greater than C50-45AN at any concentration examined.

Although various examples have been depicted and described in detail herein, it will be apparent to those skilled in the relevant art that various modifications, additions, substitutions and the like can be made without departing from the spirit of the invention and these are therefore considered to be within the scope of the invention defined.

What is claimed is:

1. A process to prepare a stable dispersion of nanoparticles in aqueous media, the process comprising:
combining a dispersant with the aqueous media to form a mixture, wherein the dispersant is selected from the group comprising copolymers and cyclic phosphates: and
adding nanoparticles to the mixture.

2. The process of claim 1, further comprising:
selecting one of metal oxides and mixed metal oxides as the nanoparticles to add to the mixture.

3. The process of claim 2, further comprising:
selecting metal oxides from a group comprising aluminum oxide, zinc oxide, iron oxide, cerium oxide, chromium oxide, antimony tin oxide, and indium tin oxide as the nanoparticles to add to the mixture.

4. The process of claim 1, further comprising:
selecting one of substantially spherical nanocrystalline metal oxides and substantially spherical nanocrystalline mixed metal oxides as the nanoparticles to add to the mixture.

5. The process of claim 1, further comprising:
selecting the nanoparticles generally to have a size distribution and range in mean diameter from about 1 nm to about 900 nm.

6. The process of claim 5, wherein the selecting step comprises:
selecting the nanoparticles generally to have a size distribution and range in mean diameter from about 2 nm to about 100 nm.

7. The process of claim 6, wherein the selecting step comprises:
selecting the nanoparticles generally to have a size distribution and range in mean diameter from about 5 nm to about 40 nm.

8. The process of claim 1, further comprising:
selecting the dispersant to be a copolymer having one or more functional groups capable of anchoring to a surface of at least one of the nanoparticles.

9. The process of claim 8, wherein the dispersant anchors to the nanoparticle surface through at least one of acidic interactions, basic interactions, neutral interactions, and covalent interactions.

10. The process of claim 9, wherein interaction between the dispersant and the at least one of the nanoparticles is of one of cationic character, anionic character, and neutral character.

11. The process of claim 1, wherein the dispersant is soluble in the aqueous media.

12. The process of claim 1, wherein the dispersant is a cyclic phosphate.

13. The process of claim 1, wherein the step of combining comprises:
mixing the dispersant to the aqueous media.

14. The process of claim 13 wherein the step of mixing is accomplished through one of high-shear mixing and ultrasonic mixing of the dispersant to the aqueous media.

15. The process of claim 1, wherein the step of adding comprises:
mixing the nanoparticles with the mixture.

16. The process of claim 15, wherein the step of adding is accomplished through one of high-shear mixing and ultra-sonic mixing the nanoparticles with the mixture.

17. A composition of nanoparticles dispersed in aqueous media produced by the process of claim 1.

18. The composition of claim 17, further comprising:
selecting one of metal oxides and mixed metal oxides as the nanoparticles.

19. The composition of claim 18, further comprising:
selecting metal oxides from a group comprising aluminum oxide, zinc oxide, iron oxide, cerium oxide, chromium oxide, antimony tin oxide, and indium tin oxide as the nanoparticles to add to the mixture.

20. The composition of claim 17, further comprising:
selecting one of substantially spherical nanocrystalline metal oxides and substantially spherical nanocrystalline mixed metal oxides as the nanoparticles to add to the mixture.

21. The composition of claim 17, further comprising:
selecting the nanoparticles generally to have a size distribution and range in mean diameter from about 1 nm to about 900 nm.

22. The composition of claim 21, wherein the selecting step comprises:
selecting the nanoparticles generally to have a size distribution and range in mean diameter from about 2 nm to about 100 nm.

23. The composition of claim 22, wherein the selecting step comprises:
selecting the nanoparticles generally to have a size distribution and range in mean diameter from about 5 nm to about 40 nm.

24. The composition of claim 17, further comprising:
selecting the dispersant to be a copolymer.

25. The composition of claim 24, further comprising:
selecting the dispersant to have one or more functional groups capable of anchoring to a surface of at least one of the nanoparticles.

26. The composition of claim 25, wherein the copolymeric dispersant anchors to the nanoparticle surface through at least one of acidic interactions, basic interactions, neutral interactions, and covalent interactions.

27. The composition of claim 26, wherein interaction between the copolymeric dispersant and the at least one of the nanoparticles is of one of cationic character, anionic character, and neutral character.

28. The composition of claim 17, wherein the dispersant is soluble in the aqueous media.

29. The composition of claim 17, wherein the dispersant is cyclic phosphate-based.
